(19) United States
(12) Patent Application Publication
(10) Pub. No.: US 2014/0169726 A1
(43) Pub. Date: Jun. 19, 2014

(54) WAVEGUIDE LENS WITH MODULATING ELECTRODE AND GROUND ELECTRODES

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/736,953

(22) Filed: Jan. 9, 2013

(30) Foreign Application Priority Data
Dec. 17, 2012 (TW) 101147744

(51) Int. Cl. G02F 1/29; G02F 1/00

(52) U.S. Cl. CPC G02F 1/292; G02F 1/0018
USPC 385/10

(57) ABSTRACT

A waveguide lens includes a substrate, a planar waveguide, a media grating, a modulating electrode, and two ground electrodes. The planar waveguide is formed on the substrate and is coupled with a laser light source which emits a laser beam into the planar waveguide. The media grating is formed on the planar waveguide. The modulating electrode is positioned on and covers the media grating. The ground electrodes are positioned on the planar waveguide and arranged at opposite sides of the media grating. The modulating electrode and the ground electrodes cooperatively change an effective refractive index of the planar waveguide to alter the effective focal length of the diffractive waveguide lens, utilizing an electro-optical effect, when an electric field is applied thereto.

### BACKGROUND

1. Technical Field

The present disclosure relates to integrated optics, and particularly to a waveguide lens.

2. Description of Related Art

Lasers are used as light sources in integrated optics as the lasers have excellent directionality, as compared to conventional light sources. However, laser beams emitted by the lasers still have a divergence angle. As such, if the laser is directly connected to an optical element, some divergent rays may not be able to enter into the optical element, decreasing light usage.

Therefore, it is desirable to provide a waveguide lens, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a waveguide lens, according to an embodiment.

FIG. 2 is a cross-sectional view taken along a line II-II of FIG. 1.

FIG. 3 is a schematic view of a media grating of the waveguide lens of FIG. 1.

### DETAILED DESCRIPTION

Embodiments of the present disclosure will be described with reference to the drawings.

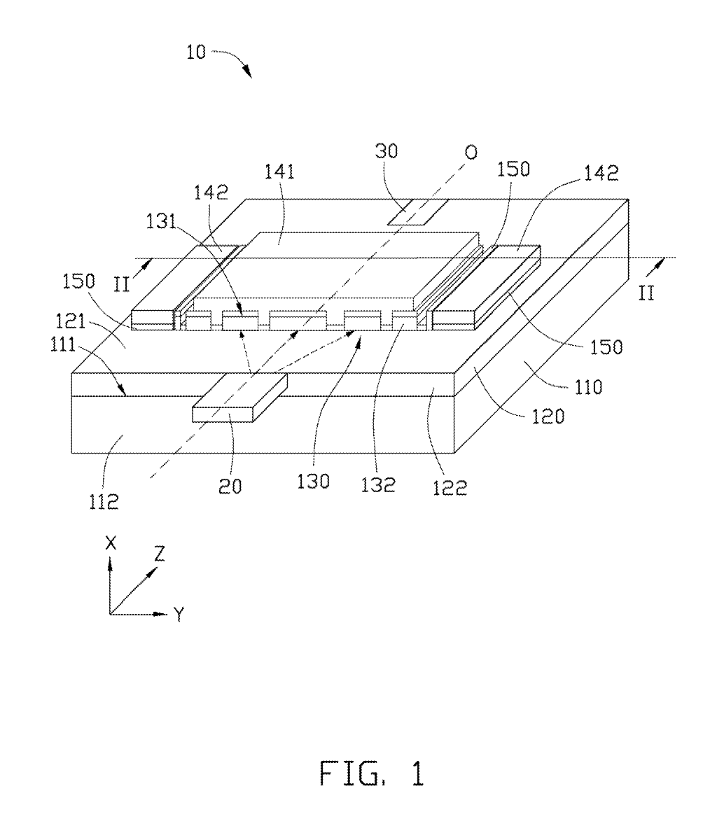

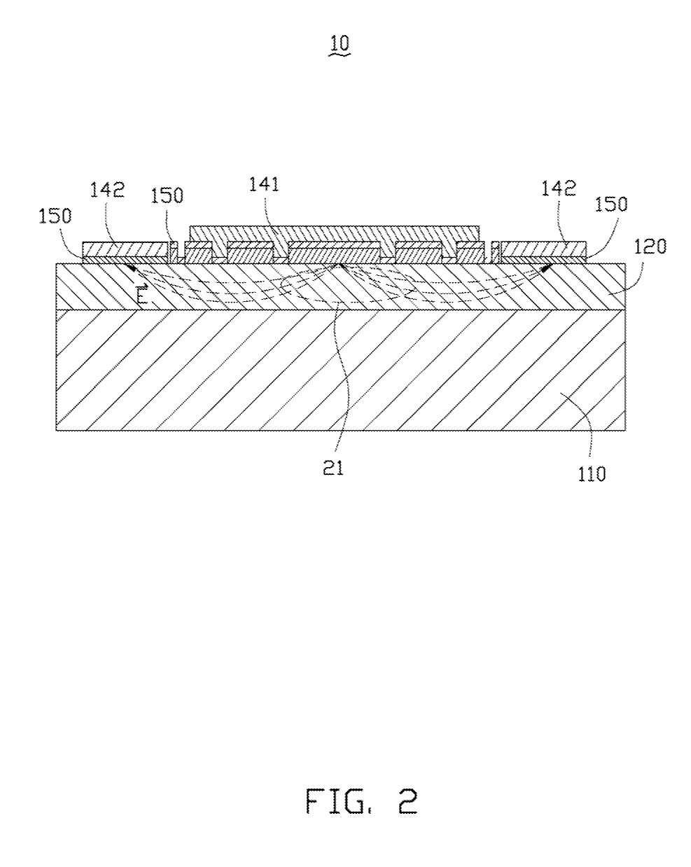

Referring to FIGS. 1-2, a waveguide lens 10, according to an embodiment, includes a substrate 110, a planar waveguide 120 formed on the substrate 110, a media grating 130 formed on the planar waveguide 120, a modulating electrode 141 positioned on and covering the media grating 130, and two ground electrodes 142 positioned on the planar waveguide 120. The two ground electrodes 142 are positioned at two sides of the media grating 130. The planar waveguide 120 is coupled with a laser light source 20 which emits a laser beam 21 into the planar waveguide 120. The light beam 21 has a divergent angle and an optical axis O. The media grating 130 is arranged along a direction that is substantially parallel with the optical axis O. The media grating 130 and the planar waveguide 120 constitute a diffractive waveguide lens to converge the laser beam 21 into an optical element 30. The modulating electrode 141 and the ground electrodes 142 cooperatively change an effective refractive index of the planar waveguide 120 to change an effective focal length of the diffractive waveguide lens, utilizing an electro-optical effect, when a modulating electric field \vec{E} is applied thereto.

In detail, the media grating 130 includes a number of media strips 132. Each media strip 132 and the planar waveguide 120 cooperatively form a strip-loaded waveguide. An effective refractive index of portions of the planar waveguide 120 where each media strip 132 is located (i.e., a portion of the planar waveguide 120 beneath each media strip 132) is increased. As such, by properly constructing the media grating 130, for example, constructing the media grating 130 as a chirped grating, the media grating 130 and the planar waveguide 120 can function as, e.g., a chirped diffractive waveguide lens.

By virtue of the modulating electrode 141 and the ground electrodes 142, and the accompanying modulating electric field \vec{E}, the effective focal length of the diffractive waveguide lens can be adjusted as desired to ensure the effective convergence of the laser beam 21 into an optical element 30 at any distance from the laser light source 20.

In addition, in a coordinate system XYZ, wherein the X axis is a height direction of the planar waveguide 12 (i.e., perpendicular to the optical axis O and to the media grating 130), the Y axis is a width direction of the planar waveguide 12 (i.e., perpendicular to the optical axis O but parallel to the media grating 130), and the Z axis is a length direction of the planar waveguide 12 (i.e., along the optical axis O), a portion of the electric field \vec{E} overlapping with the laser beam 21 is substantially parallel to the X axis. According to wave theory of planar waveguides, the laser beam 21 includes a transverse electric field (TE mode) and a transverse magnetic electric field (TM mode). The TE mode only has an electric field component \vec{Ey} vibrating along the Y axis. The TM mode only has an electric field component \vec{Ex} vibrating along the X axis and an \vec{Ez} field vibrating along the Z axis. As such, the electric field \vec{E} can effectively modulate the TM mode of the laser beam 21, as the electric field \vec{E} is parallel with the vibration direction of the electric field component \vec{Ex}.

The substrate 110 is substantially rectangular and includes a first top surface 111 and a first side surface 112. In this embodiment, the substrate 110 is made of lithium niobate (LiNbO₃) crystal.

The planar waveguide 120 is substantially rectangular and formed on the first top surface 111. The planar waveguide 120 includes a second top surface 121, opposite to the first top surface 11, and a second side surface 122, perpendicular connecting with the second top surface 121 and being coplanar with the first side surface 111. The planar waveguide 120 is made of LiNbO₃ crystal diffused with titanium (Ti: LiNbO₃), of which the effective refractive index gradually changes across the media grating 130, creating a the diffractive waveguide lens.

The media grating 130 is formed on the second top surface 121 and includes a third top surface 131 opposite to the second top surface 121. The media grating 130 is also made of (Ti: LiNbO₃) too. The media grating 130 is a chirped grating in this embodiment. There are an odd number of the media strips 132, including a central media strip 132 (hereinafter the central media strip 132), and an even number of side media strips 132 (hereinafter the side media strips 132), the number of side media strips 132 being equally divided on two sides of the central media strip 132. All the media strips 132, including the central media strip 132 which is nominally split into two equal parts by the optical axis O, are symmetrical about the optical axis O of the media grating 130. Each of the media strips 132 is rectangular and parallel. In order from the optical axis O sideways and outwards, widths of the media strips 132 decrease, and widths of gaps between each two adjacent media strips 132 also decrease.

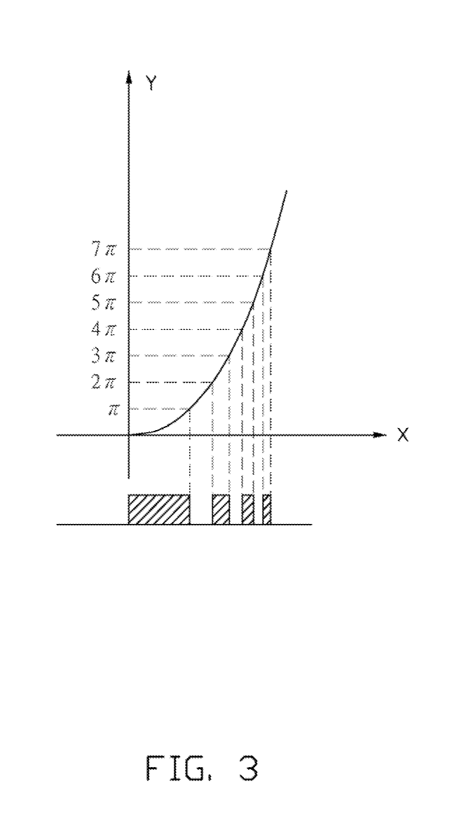

Referring to FIG. 3, a coordinate system oxy is established, wherein the origin o is an intersecting point of the optical axis O and a width direction of the planar waveguide 120, the x axis is the width direction of the planar waveguide 120, and the y axis is a phase shift of the laser beam 21 at any point along the x axis. According to wave theory of planar waveguides, y=a(1−e^{kx}^{²}), x>0, a, e, and k are constants. In this embodiment, boundaries of the media strips 132 conform with the conditions of the formulae: yₙ=a(1−e^{kx}^{ₙ}²) and yₙ=nπ, wherein xₙ is the nth boundary of the media strips 132 along the “x” axis, and yₙ is the corresponding phase shift. That is,

$${x}_{n} = \sqrt{\frac{ln ( 1 - \frac{n π}{a} )}{k}} ( {x}_{n} > 0 ) .$$

The boundaries of the media strips 132 are where xₙ<0 can be determined by the characteristics of symmetry of the media grating 130.

The modulating electrode 141 is substantially identical to the media grating 130 in shape and size and aligns with the media grating 130. That is, the modulating electrode 141 is also nominally split into two equal parts about the optical axis O. The ground electrodes 142 are symmetrical about the optical axis O and aligned lengthwise with the media grating 130 so as to be parallel to the media strips 132. A length of each of the ground electrodes 142 is at least equal to a length of the media grating 130, and a height of each of the ground electrodes 142 is at least equal to a height to the media grating 130. As such, the modulating electric field \vec{E} can effectively modulate the effective refractive index of the planar waveguide 120 through which the light beam 21 passes.

To avoid the light beam 21 being absorbed by the modulating electrode 141 and the ground electrodes 142, the waveguide lens 10 further includes a buffer layer 150 sandwiched between the media grating 130 and the modulating electrode 141, and between the planar waveguide 120 and the ground electrodes 142. The buffer layer 150 can be made of silicon dioxide.

The laser light source 20 can be a distributed feedback laser, and is attached to a portion of the side surface 112 corresponding to the planar waveguide 120.

The optical element 30 can be a strip waveguide, an optical fiber, or a splitter.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the possible scope of the disclosure but do not restrict the scope of the disclosure.

What is claimed is:

1. A waveguide lens, comprising:
a substrate;
a planar waveguide formed on the substrate and used for coupling with a laser light source which emits a laser beam having a divergent angle into the planar waveguide;
a media grating formed on the planar waveguide and arranged along a direction that is substantially parallel with an optical axis of the laser beam;
a modulating electrode positioned on and covering the media grating; and
two ground electrodes positioned on the planar waveguide and arranged at two opposite sides of the media grating, the modulating electrode and the ground electrodes being configured to change an effective refractive index of the planar waveguide, utilizing electro-optical effect, when a modulating electric filed is applied thereto.

2. The waveguide lens of claim 1, wherein the substrate is made of lithium niobate crystal.

3. The waveguide lens of claim 1, wherein the planar waveguide is made of lithium niobate crystal diffused with titanium.

4. The waveguide lens of claim 1, wherein the media grating is made of lithium niobate crystal diffused with titanium.

5. The waveguide lens of claim 1, wherein the substrate is substantially rectangular and comprises a first top surface and a first side surface perpendicularly connecting the top surface, the planar waveguide is formed on the first top surface and comprises a second top surface opposite to the first top surface and a second side surface perpendicularly connecting the second top surface and coplanar with the first side surface, the media grating is positioned on the second top surface and comprises a third top surface opposite to the second top surface, and the laser light source is attached to the second side surface.

6. The waveguide lens of claim 1, wherein the media grating is a chirped grating.

7. The waveguide lens of claim 1, wherein the media grating comprises a plurality of media strips, the number of the media strips is odd, the media strips are symmetrical about the optical axis, each of the media strips is rectangular and parallel with each other and the optical axis, in a direction from the optical axis to each outmost media strip, widths of the media strips decrease, and widths of gaps between each two adjacent media strips also decrease.

8. The waveguide lens of claim 7, wherein a coordinate axis ox is established, wherein the origin o is an intersecting point of the optical axis and a width direction of the planar waveguide, and x axis is the width direction of the planar waveguide, boundaries of the media strips are set to conform the following formulae:
$${x}_{n} = \sqrt{\frac{ln ( 1 - \frac{n π}{a} )}{k}} ,$$
and xₙ>0, wherein xₙ is the nth boundary of the media strips along the x axis, and a, and k are constants.

9. The waveguide lens of claim 7, wherein the ground electrodes are symmetrical about the optical axis and lengthwisely aligned with the media grating so as to be parallel to the media strips, a length of each of the ground electrodes is longer or equal to a length of the media grating, and a height of each of the ground electrodes is greater than or equal to a height of the media grating.

10. The waveguide lens of claim 1, further comprising a buffer layer sandwiched between the planar waveguide and the ground electrodes, and between the media grating and the modulating electrode, the buffer layer being configured for preventing the light beam from being absorbed by the ground electrodes and the modulating electrode.

11. The waveguide lens of claim 10, wherein the buffer layer is made of silicon dioxide.
